(19) United States
(12) Patent Application Publication
(10) Pub. No.: US 2025/0004230 A1
(43) Pub. Date: Jan. 2, 2025

(54) ASSEMBLY COMPONENT FOR MOUNTING CYLINDRICAL OPTICAL FIBER TERMINAL BOX

(71) Applicant: ACCELIGHT TECHNOLOGIES (WUHAN) INC., Wuhan (CN)

(72) Inventors: Hengzhi FAN, Wuhan (CN); Wenbing ZHU, Wuhan (CN); Gong-En GU, Wuhan (CN)

(21) Appl. No.: 18/630,063

(22) Filed: Apr. 9, 2024

Related U.S. Application Data
(63) Continuation of application No. PCT/CN2023/118536, filed on Sep. 13, 2023.

(30) Foreign Application Priority Data
Jun. 29, 2023 (CN) 202310784473.4

(51) Int. Cl. G02B 6/44

(52) U.S. Cl. CPC G02B 6/4446; G02B 6/44524

(57) ABSTRACT

The invention discloses an assembly component for mounting a cylindrical optical fiber terminal box, comprising a first pole mounting bracket and a second pole mounting bracket, wherein a distance between inner end faces of two third flanges corresponds to a distance between outer end faces of two second flanges; a cross-sectional shape of a first flange corresponds to a shape of a third hole; and when the first flange is inserted into the third hole, second holes correspond to fourth holes one by one, and an openable and closable locking piece is socketed in the second hole and the fourth hole.

### CROSS-REFERENCE TO RELATED APPLICATIONS

This application is a continuation application of PCT Patent Application Serial No. PCT/CN2023/118536, filed Sep. 13, 2023, which itself claims priority to Chinese Patent Application No. 202310784473.4, filed Jun. 29, 2023, which are hereby incorporated herein in their entireties by reference.

### TECHNICAL FIELD

The present invention relates generally to the technical field of optical modules, and more particularly to an assembly component for mounting a cylindrical optical fiber terminal box.

### BACKGROUND

An optical fiber splice closure is mainly applicable to straight-through and branch connection of optical cables of various structures that are laid in a manner such as aerial laying, pipe laying, and directly-buried laying. The optical fiber splice closure is generally applied to different scenarios according to customer requirements, for example, being directly mounted on a wall, being mounted on a utility pole by means of a hoop, or being hung on a household cable. For a cuboid optical fiber splice closure, an existing mounting bracket can be completely adapted to the above scenarios. However, for a cylindrical optical fiber terminal box, an outer circumferential surface of the terminal box is not flat, which cannot be adapted to the mounting bracket effectively, and therefore, smooth mounting of the cylindrical optical fiber terminal box in various scenarios cannot be ensured. Even if the cylindrical optical fiber terminal box is assembled by means of the mounting bracket in the prior art, the cylindrical optical fiber terminal box cannot be adapted and mounted to the utility pole, wall or rope, a risk of falling off may be caused. Meanwhile, the mounting bracket in the prior art is not conducive to smooth switching of various scenarios. Therefore, it is urgent to develop an assembly component for mounting a cylindrical optical fiber terminal box, so that the cylindrical optical fiber terminal box can be adapted to three mounting scenarios, i.e., mounting on the wall, mounting on the utility pole, and hanging on the household cable.

### SUMMARY

The technical problem to be solved by the present invention is to provide an assembly component for mounting a cylindrical optical fiber terminal box, aiming at defects in the prior art. The assembly component not only has the advantages of simple structure and convenience in production, manufacture and assembly, but also can conveniently and quickly enable the cylindrical optical fiber terminal box to be adapted to three mounting scenarios, i.e., mounting on a wall, mounting on a utility pole and hanging on a household cable.

The technical solution used by the present invention to solve the technical problem thereof is that:

the present invention discloses an assembly component for mounting a cylindrical optical fiber terminal box, comprising a first pole mounting bracket and a second pole mounting bracket, where

the first pole mounting bracket comprises a first base plate, the first base plate is provided with a first flange, two opposite second flanges distributed in parallel, and an arc-shaped flange distributed opposite to the first flange, a radius of the arc-shaped flange corresponds to a diameter of a to-be-mounted cylindrical optical fiber terminal box, the arc-shaped flange is provided with a first hole for mounting a first hoop, and the second flange is provided with a second hole;

the second pole mounting bracket comprises a second base plate, a U-shaped folded portion is disposed on the second base plate, a third hole penetrating along a direction of a long central axis of the second base plate is disposed on the U-shaped folded portion, a third flange extending perpendicular to a direction of the second base plate is disposed on two sides of the U-shaped folded portion, the third flange is provided with a fourth hole, and two sides of the second base plate are symmetrically provided with grooves for adapting to a second hoop and mounting the second hoop on a utility pole;

a distance between inner end faces of the two third flanges corresponds to a distance between outer end faces of the two second flanges; a cross-sectional shape of the first flange corresponds to a shape of the third hole; and

when the first flange is inserted into the third hole, the second holes correspond to the fourth holes one by one, and an openable and closable locking piece is socketed in the second hole and the fourth hole.

the present invention discloses an assembly component for mounting a cylindrical optical fiber terminal box, comprising a first pole mounting bracket and a second pole mounting bracket, where

the first pole mounting bracket comprises a first base plate, the first base plate is provided with a first flange, two opposite second flanges distributed in parallel, and an arc-shaped flange distributed opposite to the first flange, a radius of the arc-shaped flange corresponds to a diameter of a to-be-mounted cylindrical optical fiber terminal box, the arc-shaped flange is provided with a first hole for mounting a first hoop, and the second flange is provided with a second hole;

the second pole mounting bracket comprises a second base plate, a U-shaped folded portion is disposed on the second base plate, a third hole penetrating along a direction of a long central axis of the second base plate is disposed on the U-shaped folded portion, a third flange extending perpendicular to a direction of the second base plate is disposed on two sides of the U-shaped folded portion, the third flange is provided with a fourth hole, and the second base plate is provided with a fixed hole group for fixedly connecting the second base plate to a wall;

a distance between inner end faces of the two third flanges corresponds to a distance between outer end faces of the two second flanges; a cross-sectional shape of the first flange corresponds to a shape of the third hole; and

when the first flange is inserted into the third hole, the second holes correspond to the fourth holes one by one, and an openable and closable locking piece is socketed in the second hole and the fourth hole.

In a preferred embodiment of the present invention, the fixed hole group comprises gourd-shaped holes located at two ends and a circular hole located in the middle, and the gourd-shaped holes and the circular hole are socketed with an expansion screw, respectively.

In a preferred embodiment of the present invention, both the second hole and the fourth hole are waist-shaped holes.

In a preferred embodiment of the present invention, the first flange is perpendicular to the first base plate, the second flange is perpendicular to the first base plate, and the first flange is fixedly connected to a first plate body portion by means of a screw passing through a third mounting hole.

In a preferred embodiment of the present invention, the locking piece comprises a stepped rod and an elastically deformable U-shaped blocking rod, and one end of the U-shaped blocking rod is hinged to the stepped rod, and the other end thereof is sleeved on the stepped rod.

The present invention further discloses an assembly component for mounting a cylindrical optical fiber terminal box, comprising a base plate portion, where an end of the base plate portion is provided with an arc-shaped flange portion, a radius of the arc-shaped flange portion corresponds to a diameter of a to-be-mounted cylindrical optical fiber terminal box, the arc-shaped flange portion is provided with a hole for mounting a first hoop, and the other end of the base plate portion is provided with a clamping head portion for connecting a rope.

In a preferred embodiment of the present invention, the clamping head portion comprises an L-shaped flange portion distributed perpendicular to the base plate portion, and a cover plate portion for cooperating with the L-shaped flange portion, two sides of the L-shaped flange portion and the cover plate portion are both provided with flanges, the flanges are provided with semicircular holes distributed in a one-to-one correspondence manner, and the L-shaped flange portion is fixedly connected to the cover plate portion by means of a locking piece.

In a preferred embodiment of the present invention, a middle portion of both the L-shaped flange portion and the cover plate portion is correspondingly provided with a locking hole.

In a preferred embodiment of the present invention, the locking piece comprises a nut coaxially riveted at the locking hole of the L-shaped flange portion and a locking screw rod for cooperating with the nut.

In a preferred embodiment of the present invention, two ends of the arc-shaped flange are provided with an edgefold distributed at an obtuse angle to the arc-shaped flange, and the edgefold is provided with the first hole.

Beneficial effects of the present invention are as follows:

1. The present invention can be adapted to the mounting of a cylindrical optical fiber terminal box, so that the terminal box can be conveniently applied to the following environments: a. being pole-mounted on a utility pole; b. being mounted on a wall body; and c. being mounted on an optical cable routing steel rope by means of hanging, thereby improving the compatibility of the cylindrical optical fiber terminal box.

2. In the present invention, a first pole mounting bracket and a second pole mounting bracket are introduced, and the first pole mounting bracket and the second pole mounting bracket are cooperated by means of a detachable insertion structure, the assembly of the two can be conveniently and quickly realized. At the same time, a hoop is disposed on the first pole mounting bracket, so that the assembly between the first pole mounting bracket and the cylindrical optical fiber terminal box is realized. The present invention can not only satisfy the assembly of cylindrical optical fiber terminal boxes of various sizes, but also facilitate the switching of the cylindrical optical fiber terminal box between a wall and a utility pole.

3. Both the first pole mounting bracket and the second pole mounting bracket of the present invention are sheet metal pieces, and have the advantages of light weight, low cost, good replacement performance, and convenient assembly.

4. The present invention further discloses an assembly component for adapting to a cable, comprising a base plate portion, where an end of the base plate portion is provided with an arc-shaped flange, a radius of the arc-shaped flange corresponds to a diameter of a to-be-mounted cylindrical optical fiber terminal box, the arc-shaped flange is provided with a first hole for mounting a first hoop, and the other end of the base plate portion is provided with a clamping head portion for connecting a rope. The sheet metal piece is simple in structure and low in cost.

Furthermore, by using the sheet metal piece, the cylindrical optical fiber terminal box can be stably clamped by means of the hoop, and the mounting of the cylindrical optical fiber terminal box and the cable can be quickly realized by means of the clamping head.

5. The arc-shaped flange of the present invention is designed to be stably attached to an outer end face of the cylindrical optical fiber terminal box, thereby ensuring the stable attachment between the assembly component and the cylindrical optical fiber terminal box, and further ensuring stability and safety of the mounting of the cylindrical optical fiber terminal box.

6. Two ends of the arc-shaped flange 14 of the present invention are provided with an edgefold distributed at an obtuse angle to the arc-shaped flange, and the edgefold is provided with the first hole. The existence of the edgefold is more conducive to the mounting of a hoop.

### BRIEF DESCRIPTION OF DRAWINGS

The following further describes the present invention with reference to the accompanying drawings and embodiments, in which:

FIG. 1 is a schematic diagram of mounting a cylindrical optical fiber terminal box on a utility pole by means of an assembly component according to the present invention;

FIG. 2 is a schematic diagram of an assembly component for mounting a cylindrical optical fiber terminal box according to the present invention;

FIG. 3 is a schematic diagram of an assembly component for mounting a cylindrical optical fiber terminal box according to the present invention;

FIG. 4 is an exploded view of FIG. 3;

FIG. 5 is a schematic diagram of a first pole mounting bracket in a schematic diagram of an assembly component for mounting a cylindrical optical fiber terminal box according to the present invention;

FIG. 6 is a schematic diagram of a second pole mounting bracket in a schematic diagram of an assembly component for mounting a cylindrical optical fiber terminal box according to the present invention;

FIG. 7 is a partial enlarged view of a second pole mounting bracket in a schematic diagram of an assembly component for mounting a cylindrical optical fiber terminal box according to the present invention;

FIG. 8 is a schematic diagram of a locking piece in a schematic diagram of an assembly component for mounting a cylindrical optical fiber terminal box according to the present invention;

FIG. 9 is a schematic diagram of a locking piece in a schematic diagram of an assembly component for mounting a cylindrical optical fiber terminal box according to the present invention;

FIG. 10 is a schematic diagram of mounting a cylindrical optical fiber terminal box on a wall by means of an assembly component according to the present invention;

FIG. 11 is a schematic diagram of an assembly component for mounting a cylindrical optical fiber terminal box according to the present invention;

FIG. 12 is a schematic diagram of an assembly component for mounting a cylindrical optical fiber terminal box according to the present invention;

FIG. 13 is an exploded view of FIG. 12;

FIG. 14 is a schematic diagram of mounting a cylindrical optical fiber terminal box on a cable by means of an assembly component according to the present invention;

FIG. 15 is a schematic diagram of an assembly component for mounting a cylindrical optical fiber terminal box according to the present invention;

FIG. 16 is a schematic diagram of an assembly component for mounting a cylindrical optical fiber terminal box according to the present invention;

FIG. 17 is an exploded view of FIG. 16;

FIG. 18 is an enlarged view of FIG. 16; and

FIG. 19 is a schematic diagram of a cover plate portion of an assembly component for mounting a cylindrical optical fiber terminal box according to the present invention.

### DETAILED DESCRIPTION OF THE EMBODIMENTS

To make objectives, technical solutions, and advantages of the present invention more clearly, the following further describes the present invention in detail with reference to the accompanying drawings and embodiments. It should be understood that the specific embodiments described herein are merely intended to explain the present invention, but not to limit the present invention.

### Embodiment 1

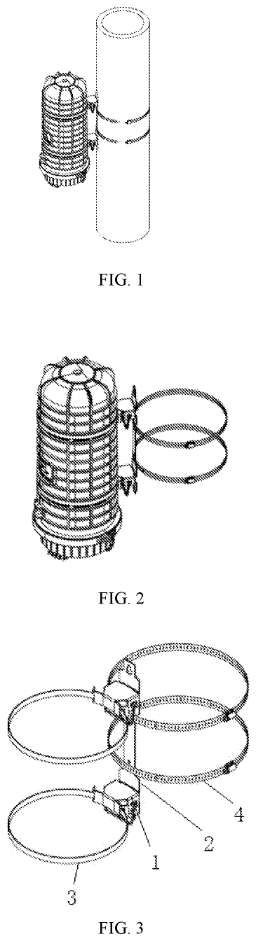

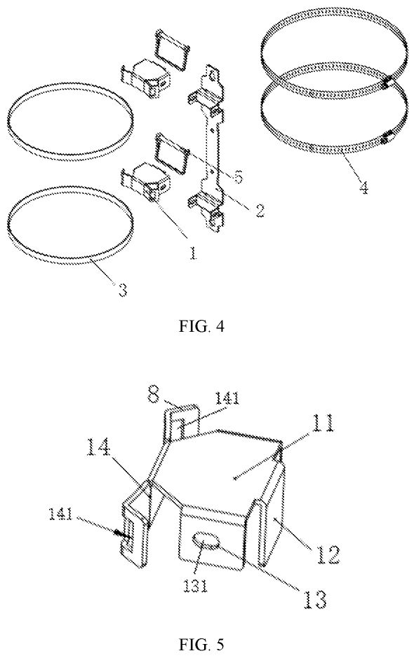

As shown in FIGS. 1 to 4, the embodiments of the present invention disclose an assembly component, which is used for vertically mounting a cylindrical optical fiber terminal box onto a utility pole, and has the advantages of simple structure, convenient assembly, and safety and stability.

An assembly component for mounting a cylindrical optical fiber terminal box according to the present invention comprises a first pole mounting bracket 1 and a second pole mounting bracket 2, where

as shown in FIG. 5, the first pole mounting bracket 1 comprises a first base plate 11, the first base plate 11 is provided with a first flange 12, two opposite second flanges 13 distributed in parallel, and an arc-shaped flange 14 distributed opposite to the first flange 12, a radius of the arc-shaped flange 14 corresponds to a diameter of a to-be-mounted cylindrical optical fiber terminal box, the arc-shaped flange 14 is provided with a first hole 141 for mounting a first hoop 3, and the second flange 13 is provided with a second hole 131;

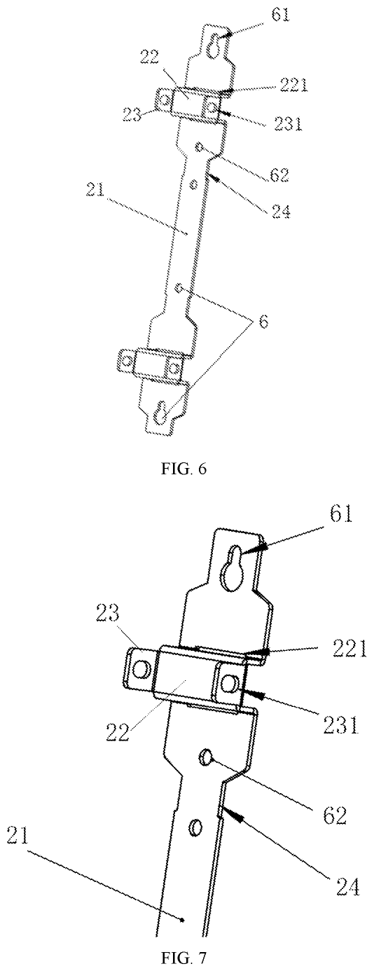

as shown in FIGS. 6 to 7, the second pole mounting bracket 2 comprises a second base plate 21, a U-shaped folded portion 22 is disposed on the second base plate 21, a third hole 221 penetrating along a direction of a long central axis of the second base plate 21 is disposed on the U-shaped folded portion 22, a third flange 23 extending perpendicular to a direction of the second base plate 21 is disposed on two sides of the U-shaped folded portion 22, the third flange 23 is provided with a fourth hole 231, two sides of the second base plate 21 are symmetrically provided with grooves 24 for adapting to a second hoop 4 and mounting the second hoop on a utility pole, and the existence of the grooves 24 enables the second hoop 4 to hold the second pole mounting bracket 2 without falling down;

a distance between inner end faces of the two third flanges 23 corresponds to a distance between outer end faces of the two second flanges 13; a cross-sectional shape of the first flange 12 corresponds to a shape of the third hole 221; and

when the first flange 12 is inserted into the third hole 221, the second holes 131 correspond to the fourth holes 231 one by one, and an openable and closable locking piece 5 is socketed in the second hole 131 and the fourth hole 231. After assembly, the first base plate 11 and the second base plate 21 are perpendicular to each other.

The cooperation between the first flange 12 and the third hole 221 realizes a limit in a front and rear direction between the first pole mounting bracket 1 and the second pole mounting bracket 2, the cooperation between the third flange 23 and the second flange 13 realizes a limit in a left and right direction between the first pole mounting bracket 1 and the second pole mounting bracket 2, and the existence of the locking piece 5 realizes a limit in an up and down direction between the first pole mounting bracket 1 and the second pole mounting bracket 2.

The first hoop 3 of the present invention can be used to enlarge or narrow the ring of a hose clamp by loosening or tightening a screw thereon, so as to adapt to cylindrical optical fiber terminal boxes of various models and sizes.

Preferably, both the first pole mounting bracket 1 and the second pole mounting bracket 2 of the present invention are metal bending pieces, which can be directly stamped and formed by means of a sheet metal, and have the advantages of convenience in processing and good interchangeability.

Preferably, both the second hole 131 and the fourth hole 231 of the present invention are waist-shaped holes.

Preferably, the first flange 12 is perpendicular to the first base plate 11, the second flange 13 is perpendicular to the first base plate 11, and the first flange 12 is fixedly connected to a first plate body portion by means of a screw 521 passing through a third mounting hole 516.

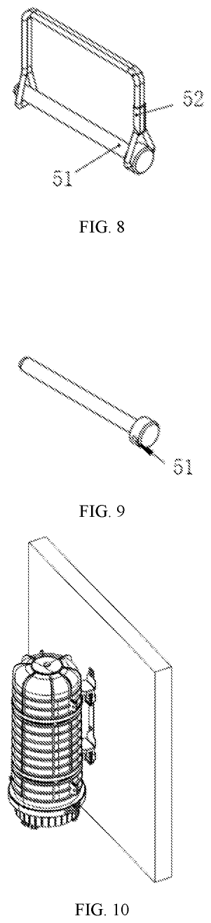

Preferably, as shown in FIGS. 8 to 9, the locking piece 5 comprises a stepped rod 51 and an elastically deformable U-shaped blocking rod 52, one end of the U-shaped blocking rod 52 is hinged to the stepped rod 51, and the other end thereof is sleeved on the stepped rod 51. Specifically, the U-shaped blocking rod 52 is composed of spring steel wires at two ends, and a large cylinder end of the stepped rod 51 is provided with a through-hole penetrating in a radial direction thereof, a spring steel wire is inserted into the through-hole, and after being inserted into the through-hole, the spring steel wire is bent into a triangular shape and is wrapped by a metal patch, the other end of the spring steel wire can be sleeved on or unwrapped from a small cylindrical rod of the stepped rod 51 by means of the deformation of the spring steel wire. When sleeved, the U-shaped blocking rod 52 can form a complete lock catch.

Preferably, two ends of the arc-shaped flange 14 are provided with an edgefold 8 distributed at an obtuse angle to the arc-shaped flange, and the edgefold 8 is provided with the first hole 141.

Preferably, the second base plate 21 is provided with a fixed hole group 6 for fixedly connecting the second base plate to a wall, the fixed hole group 6 comprises gourd-shaped holes 61 located at two ends and a circular hole 62 located in the middle, and the gourd-shaped holes 61 and the circular hole 62 are socketed with an expansion screw, respectively. In this way, the second pole mounting bracket 2 in this embodiment can be compatible with vertical mounting of a wall body at the same time.

The assembly component disclosed in this embodiment can not only stabilize the connection between the assembly component and cylindrical optical fiber terminal boxes of various sizes, but also assemble the cylindrical optical fiber terminal boxes on the utility pole conveniently and quickly, and at the same time, even if a certain part is damaged, the replacement of a single component part can also be implemented, thereby effectively reducing the maintenance cost of the cylindrical optical fiber terminal box.

### Embodiment 2

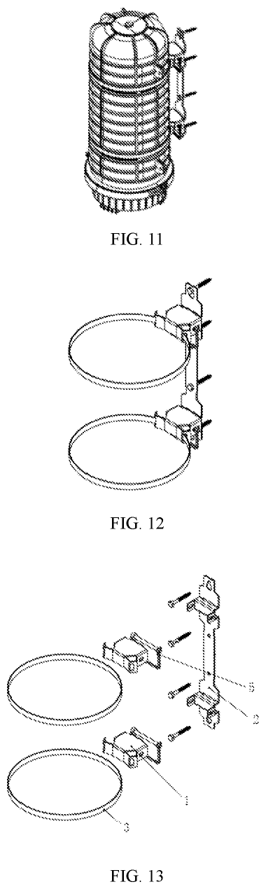

As shown in FIGS. 10 to 13, the embodiments of the present invention disclose an

assembly component, which is used for vertically mounting a cylindrical optical fiber terminal box onto a flat wall, and has the advantages of simple structure, convenient assembly, and safety and stability.

An assembly component for mounting a cylindrical optical fiber terminal box according to the present invention comprises a first pole mounting bracket 1 and a second pole mounting bracket 2, where

the first pole mounting bracket 1 comprises a first base plate 11, the first base plate 11 is provided with a first flange 12, two opposite second flanges 13 distributed in parallel, and an arc-shaped flange 14 distributed opposite to the first flange 12, a radius of the arc-shaped flange 14 corresponds to a diameter of a to-be-mounted cylindrical optical fiber terminal box, the arc-shaped flange 14 is provided with a first hole 141 for mounting a first hoop 3, and the second flange 13 is provided with a second hole 131;

the second pole mounting bracket 2 comprises a second base plate 21, a U-shaped folded portion 22 is disposed on the second base plate 21, a third hole 221 penetrating along a direction of a long central axis of the second base plate 21 is disposed on the U-shaped folded portion 22, a third flange 23 extending perpendicular to a direction of the second base plate 21 is disposed on two sides of the U-shaped folded portion 22, the third flange 23 is provided with a fourth hole 231, and the second base plate 21 is provided with a fixed hole group 6 for fixedly connecting the second base plate to a wall;

a distance between inner end faces of the two third flanges 23 corresponds to a distance between outer end faces of the two second flanges 13; a cross-sectional shape of the first flange 12 corresponds to a shape of the third hole 221; and

when the first flange 12 is inserted into the third hole 221, the second holes 131 correspond to the fourth holes 231 one by one, and an openable and closable locking piece 5 is socketed in the second hole 131 and the fourth hole 231. After assembly, the first base plate 11 and the second base plate 21 are perpendicular to each other.

The cooperation between the first flange 12 and the third hole 221 realizes a limit in a front and rear direction between the first pole mounting bracket 1 and the second pole mounting bracket 2, the cooperation between the third flange 23 and the second flange 13 realizes a limit in a left and right direction between the first pole mounting bracket 1 and the second pole mounting bracket 2, and the existence of the locking piece 5 realizes a limit in an up and down direction between the first pole mounting bracket 1 and the second pole mounting bracket 2.

The first hoop 3 of the present invention can be used to enlarge or narrow the ring of a hose clamp by loosening or tightening a screw thereon, so as to adapt to cylindrical optical fiber terminal boxes of various models and sizes.

Preferably, the fixed hole group 6 comprises gourd-shaped holes 61 located at two ends and a circular hole 62 located in the middle, and the gourd-shaped holes 61 and the circular hole 62 are socketed with an expansion screw, respectively. During assembly, the two expansion screws are pre-fixed on the wall without locking, and then the second pole mounting bracket 2 is hung onto the upper and lower expansion screws, the gourd-shaped hole is large at the bottom and small at the top, and the second pole mounting bracket 2 can penetrate a screw cap of the expansion screw through the large hole of the gourd-shaped hole. After that, a part of the second pole mounting bracket 2 is moved downwards, so that the small hole of the gourd-shaped holes 61 of the second pole mounting bracket 2 is placed on the screw rod of the expansion screw. The screw cap of the expansion screw is large, so that the second pole mounting bracket 2 cannot be directly pulled out, and then two expansion screws in the middle are fixed at the circular hole 62, thereby securing the entire component to the wall.

Preferably, both the first pole mounting bracket 1 and the second pole mounting bracket 2 of the present invention are metal bending pieces, which can be directly stamped and formed by means of a sheet metal, and have the advantages of convenience in processing and good interchangeability.

Preferably, both the second hole 131 and the fourth hole 231 of the present invention are waist-shaped holes.

Preferably, the first flange 12 is perpendicular to the first base plate 11, the second flange 13 is perpendicular to the first base plate 11, and the first flange 12 is fixedly connected to a first plate body portion by means of a screw 521 passing through a third mounting hole 516.

Preferably, the locking piece 5 comprises a stepped rod 51 and an elastically deformable U-shaped blocking rod 52, one end of the U-shaped blocking rod 52 is hinged to the stepped rod 51, and the other end thereof is sleeved on the stepped rod 51. Specifically, the U-shaped blocking rod 52 is composed of spring steel wires at two ends, and a large cylinder end of the stepped rod 51 is provided with a through-hole penetrating in a radial direction thereof, after being inserted into the through-hole, the spring steel wire is bent into a triangular shape and is wrapped by a metal patch, the other end of the spring steel wire can be sleeved on or unwrapped from a small cylindrical rod of the stepped rod 51 by means of the deformation of the spring steel wire. When sleeved, the U-shaped blocking rod 52 can form a complete lock catch.

Preferably, two ends of the arc-shaped flange 14 are provided with an edgefold 8 distributed at an obtuse angle to the arc-shaped flange, and the edgefold 8 is provided with the first hole 141.

Preferably, two sides of the second base plate 21 are symmetrically provided with grooves 24 for adapting to a second hoop 4 and mounting the second hoop on a utility pole. In this way, the second pole mounting bracket 2 in this embodiment can be compatible with mounting of the utility pole.

The assembly component disclosed in this embodiment can not only stabilize the connection between the assembly component and cylindrical optical fiber terminal boxes of various sizes, but also assemble the cylindrical optical fiber terminal boxes on the wall conveniently and quickly, and at the same time, even if a certain part is damaged, the replacement of a single component part can also be implemented, thereby effectively reducing the maintenance cost of the cylindrical optical fiber terminal box.

### Embodiment 3

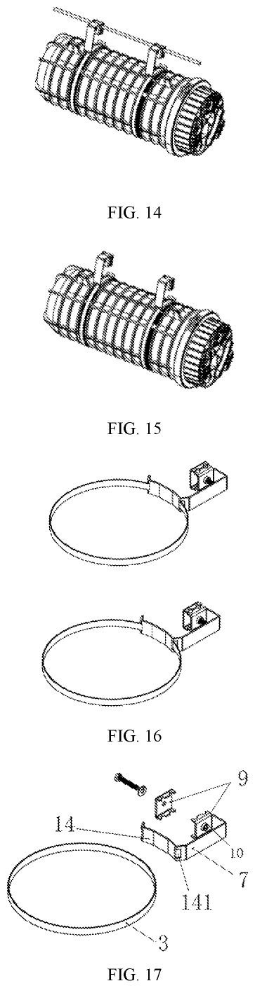

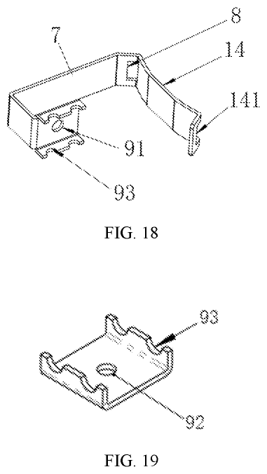

As shown in FIGS. 14 to 19, the embodiments of the present invention disclose an assembly component, which is used for hanging a cylindrical optical fiber terminal box onto a cable, and has the advantages of simple structure, convenient assembly, and safety and stability.

The present invention disclose an assembly component for mounting a cylindrical optical fiber terminal box, comprising a base plate portion 7, where an end of the base plate portion 7 is provided with an arc-shaped flange 14, a radius of the arc-shaped flange 14 corresponds to a diameter of a to-be-mounted cylindrical optical fiber terminal box, the arc-shaped flange 14 is provided with a first hole 141 for mounting a first hoop 3, and the other end of the base plate portion 7 is provided with a clamping head portion 9 for connecting a rope.

Preferably, the clamping head portion 9 comprises an L-shaped flange portion 91 distributed perpendicular to the base plate portion 7, and a cover plate portion 92 for cooperating with the L-shaped flange portion 91, two sides of the L-shaped flange portion 91 and the cover plate portion 92 are both provided with flanges 93, the flanges 93 are provided with semicircular holes 94 distributed in a one-to-one correspondence manner, a diameter of the semicircular hole 94 corresponds to a diameter of the rope/cable, and the L-shaped flange portion 91 is fixedly connected to the cover plate portion 92 by means of a locking piece.

Preferably, a middle portion of both the L-shaped flange portion 91 and the cover plate portion 92 is correspondingly provided with a locking hole; and the locking piece comprises a nut 10 coaxially riveted at the locking hole of the L-shaped flange portion 91 and a locking screw rod for cooperating with the nut 10.

Preferably, two ends of the arc-shaped flange 14 are provided with an edgefold 8 distributed at an obtuse angle to the arc-shaped flange, and the edgefold 8 is provided with the first hole 141.

The assembly component disclosed in this embodiment can not only stabilize the connection between the assembly component and cylindrical optical fiber terminal boxes of various sizes, but also hang the cylindrical optical fiber terminal boxes on the cable conveniently and quickly, and at the same time, even if a certain part is damaged, the replacement of a single component part can also be implemented, thereby effectively reducing the maintenance cost of the cylindrical optical fiber terminal box.

It should be pointed out that a connecting piece recorded in the claims and descriptions of the present invention includes, but is not limited to, a bolt, a screw, an expansion screw or the like.

It should be understood that those of ordinary skill in the art can make improvements or modifications according to the above description, and all these improvements and modifications shall fall within the protection scope of the appended claims of the present invention.

What is claimed is:

1. An assembly component for mounting a cylindrical optical fiber terminal box, comprising a first pole mounting bracket (1) and a second pole mounting bracket (2), wherein
the first pole mounting bracket (1) comprises a first base plate (11), the first base plate (11) is provided with a first flange (12), two opposite second flanges (13) distributed in parallel, and an arc-shaped flange (14) distributed opposite to the first flange (12), a radius of the arc-shaped flange (14) corresponds to a diameter of a to-be-mounted cylindrical optical fiber terminal box, the arc-shaped flange (14) is provided with a first hole (141) for mounting a first hoop (3), and the second flange (13) is provided with a second hole (131);
the second pole mounting bracket (2) comprises a second base plate (21), a U-shaped folded portion (22) is disposed on the second base plate (21), a third hole (221) penetrating along a direction of a long central axis of the second base plate (21) is disposed on the U-shaped folded portion (22), a third flange (23) extending perpendicular to a direction of the second base plate (21) is disposed on two sides of the U-shaped folded portion (22), the third flange (23) is provided with a fourth hole (231), and two sides of the second base plate (21) are symmetrically provided with grooves (24) for adapting to a second hoop (4) and mounting the second hoop on a utility pole;
a distance between inner end faces of the two third flanges (23) corresponds to a distance between outer end faces of the two-second flanges (13); a cross-sectional shape of the first flange (12) corresponds to a shape of the third hole (221); and
when the first flange (12) is inserted into the third hole (221), the second holes (131) correspond to the fourth holes (231) one by one, and an openable and closable locking piece (5) is socketed in the second hole (131) and the fourth hole (231).

2. The assembly component for mounting a cylindrical optical fiber terminal box according to claim 1, wherein both the second hole (131) and the fourth hole (231) are waist-shaped holes.

3. The assembly component for mounting a cylindrical optical fiber terminal box according to claim 1, wherein the first flange (12) is perpendicular to the first base plate (11), the second flange (13) is perpendicular to the first base plate (11), and the first flange (12) is fixedly connected to a first plate body portion by means of a screw (521) passing through a third mounting hole (516).

4. The assembly component for mounting a cylindrical optical fiber terminal box according to claim 1, wherein the locking piece (5) comprises a stepped rod (51) and an elastically deformable U-shaped blocking rod (52), and one end of the U-shaped blocking rod (52) is hinged to the stepped rod (51), and the other end thereof is sleeved on the stepped rod (51).

5. The assembly component for mounting a cylindrical optical fiber terminal box according to claim 1, wherein two ends of the arc-shaped flange (14) are provided with an edgefold (8) distributed at an obtuse angle to the arc-shaped flange, and the edgefold (8) is provided with the first hole (141).

6. An assembly component for mounting a cylindrical optical fiber terminal box, comprising a first pole mounting bracket (1) and a second pole mounting bracket (2), wherein
the first pole mounting bracket (1) comprises a first base plate (11), the first base plate (11) is provided with a first flange (12), two opposite second flanges (13) distributed in parallel, and an arc-shaped flange (14) distributed opposite to the first flange (12), a radius of the arc-shaped flange (14) corresponds to a diameter of a to-be-mounted cylindrical optical fiber terminal box, the arc-shaped flange (14) is provided with a first hole (141) for mounting a first hoop (3), and the second flange (13) is provided with a second hole (131);
the second pole mounting bracket (2) comprises a second base plate (21), a U-shaped folded portion (22) is disposed on the second base plate (21), a third hole (221) penetrating along a direction of a long central axis of the second base plate (21) is disposed on the U-shaped folded portion (22), a third flange (23) extending perpendicular to a direction of the second base plate (21) is disposed on two sides of the U-shaped folded portion (22), the third flange (23) is provided with a fourth hole (231), and the second base plate (21) is provided with a fixed hole group (6) for fixedly connecting the second base plate to a wall;
a distance between inner end faces of the two third flanges (23) corresponds to a distance between outer end faces of the two second flanges (13); a cross-sectional shape of the first flange (12) corresponds to a shape of the third hole (221); and
when the first flange (12) is inserted into the third hole (221), the second holes (131) correspond to the fourth holes (231) one by one, and an openable and closable locking piece (5) is socketed in the second hole (131) and the fourth hole (231).

7. The assembly component for mounting a cylindrical optical fiber terminal box according to claim 6, wherein the fixed hole group (6) comprises gourd-shaped holes (61) located at two ends and a circular hole (62) located in the middle, and the gourd-shaped holes (61) and the circular hole (62) are socketed with an expansion screw, respectively.

8. The assembly component for mounting a cylindrical optical fiber terminal box according to claim 6, wherein both the second hole (131) and the fourth hole (231) are waist-shaped holes.

9. The assembly component for mounting a cylindrical optical fiber terminal box according to claim 6, wherein the first flange (12) is perpendicular to the first base plate (11), the second flange (13) is perpendicular to the first base plate (11), and the first flange (12) is fixedly connected to a first plate body portion by means of a screw (521) passing through a third mounting hole (516).

10. The assembly component for mounting a cylindrical optical fiber terminal box according to claim 6, wherein the locking piece (5) comprises a stepped rod (51) and an elastically deformable U-shaped blocking rod (52), and one end of the U-shaped blocking rod (52) is hinged to the stepped rod (51), and the other end thereof is sleeved on the stepped rod (51).

11. The assembly component for mounting a cylindrical optical fiber terminal box according to claim 6, wherein two ends of the arc-shaped flange (14) are provided with an edgefold (8) distributed at an obtuse angle to the arc-shaped flange, and the edgefold (8) is provided with the first hole (141).

12. An assembly component for mounting a cylindrical optical fiber terminal box, comprising a base plate portion (7), wherein an end of the base plate portion (7) is provided with an arc-shaped flange (14), a radius of the arc-shaped flange (14) corresponds to a diameter of a to-be-mounted cylindrical optical fiber terminal box, the arc-shaped flange (14) is provided with a first hole (141) for mounting a first hoop (3), and the other end of the base plate portion (7) is provided with a clamping head portion (9) for connecting a rope.

13. The assembly component for mounting a cylindrical optical fiber terminal box according to claim 12, wherein the clamping head portion (9) comprises an L-shaped flange portion (91) distributed perpendicular to the base plate portion (7), and a cover plate portion (92) for cooperating with the L-shaped flange portion (91), two sides of the L-shaped flange portion (91) and the cover plate portion (92) are both provided with flanges (93), the flanges (93) are provided with semicircular holes (94) distributed in a one-to-one correspondence manner, and the L-shaped flange portion (91) is fixedly connected to the cover plate portion (92) by means of a locking piece.

14. The assembly component for mounting a cylindrical optical fiber terminal box according to claim 13, wherein a middle portion of both the L-shaped flange portion (91) and the cover plate portion (92) is correspondingly provided with a locking hole; and the locking piece comprises a nut (10) coaxially riveted at the locking hole of the L-shaped flange portion (91) and a locking screw rod for cooperating with the nut (10).

15. The assembly component for mounting a cylindrical optical fiber terminal box according to claim 12, wherein two ends of the arc-shaped flange (14) are provided with an edgefold (8) distributed at an obtuse angle to the arc-shaped flange, and the edgefold (8) is provided with the first hole (141).
